(19) United States
(12) Patent Application Publication
(10) Pub. No.: US 2026/0024970 A1
(43) Pub. Date: Jan. 22, 2026

(54) WIRE HARNESS

(71) Applicant: Yazaki Corporation, Tokyo (JP)

(72) Inventors: Yuto ITO, Tochigi (JP); Koji YAMAZAKI, Tochigi (JP); Jumpei KATO, Tochigi (JP); Go TATEMICHI, Tochigi (JP); Keisuke KITAJO, Tochigi (JP)

(73) Assignee: Yazaki Corporation, Tokyo (JP)

(21) Appl. No.: 19/261,143

(22) Filed: Jul. 7, 2025

(30) Foreign Application Priority Data
Jul. 17, 2024 (JP) 2024-113757

(51) Int. Cl. H02G 3/04; H01B 7/00

(52) U.S. Cl. CPC H02G 3/0468; H01B 7/0045

(57) ABSTRACT

A wire harness includes: a wiring member; a bellows-shaped corrugated tube that has a cylindrical shape and externally covers the wiring member; a resin-made hard tube that has a cylindrical shape, externally covers the corrugated tube, and forms a cut portion over an entire length along an extending direction; and a resin-made protector that has a cylindrical part, externally covers the corrugated tube, is disposed at an end portion of the hard tube, and is coupled to the hard tube.

### CROSS-REFERENCE TO RELATED APPLICATION(S)

The present application claims priority to and incorporates by reference the entire contents of Japanese Patent Application No. 2024-113757 filed in Japan on Jul. 17, 2024.

### BACKGROUND OF THE INVENTION

### 1. Field of the Invention

The present invention relates to a wire harness.

### 2. Description of the Related Art

Conventionally, as a wire harness, for example, as described in JP 2022-049 301 A, a wire harness in which a wiring member that is an electric wire member is externally covered with a metal cylindrical member is known. The wire harness is routed in a vehicle and electrically connects a plurality of electric devices.

However, the above-described wire harness has room for improvement in that it is difficult to appropriately restrict the path of the wiring member. For example, in the wire harness described above, since the path restriction and the path holding of the wiring member are performed by externally covering the metal cylindrical member, the weight of the entire wire harness increases. On the other hand, when the path is restricted by the resin-made exterior component, a large mold for manufacturing the exterior component is required, and the manufacturing cost of the exterior component increases. Therefore, it is desired to develop a technique capable of appropriately restricting the path while reducing the weight of the wire harness.

### SUMMARY OF THE INVENTION

Therefore, an object of the present invention is to provide a wire harness capable of appropriately restricting a path of a wiring member.

In order to achieve the above mentioned object, a wire harness according to one aspect of the present invention includes a wiring member; a bellows-shaped corrugated tube that has a cylindrical shape and externally covers the wiring member; a resin-made hard tube that has a cylindrical shape, externally covers the corrugated tube, and forms a cut portion over an entire length along an extending direction; and a resin-made protector that has a cylindrical part, externally covers the corrugated tube, is disposed at an end portion of the hard tube, and is coupled to the hard tube.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a wire harness according to an embodiment;

FIG. 2 is a perspective view of a hard tube of the wire harness according to the embodiment;

FIG. 3 is a cross-sectional view of the hard tube taken along line III-III in FIG. 2;

FIG. 4 is a perspective view of a protector of the wire harness according to the embodiment;

FIG. 5 is a cross-sectional view of the protector of the wire harness according to the embodiment; and

FIG. 6 is an explanatory view of the protector of the wire harness according to the embodiment.

### DETAILED DESCRIPTION OF THE PREFERRED EMBODIMENTS

Hereinafter, an embodiment according to the present invention will be described in detail with reference to the drawings. Note that the present invention is not limited by the embodiment. In addition, constituent elements in the following embodiment include those that can be easily replaced by those skilled in the art or those that are substantially the same.

### Embodiment

The present embodiment relates to a wire harness. In the following description, among the first direction, the second direction, and the third direction intersecting each other, the first direction is referred to as an “extending direction X”, the second direction is referred to as a “width direction Y”, and the third direction is referred to as a “height direction Z”. Here, the extending direction X, the width direction Y, and the height direction Z are orthogonal to each other. The extending direction X corresponds to the extending direction of the wiring member and the extending direction of the hard tube. The width direction Y and the height direction Z correspond to an intersecting direction intersecting the extending direction X. In addition, each direction used in the following description represents a direction in a state where each part is assembled to each other unless otherwise specified. The term “orthogonal” as used herein includes substantially orthogonal.

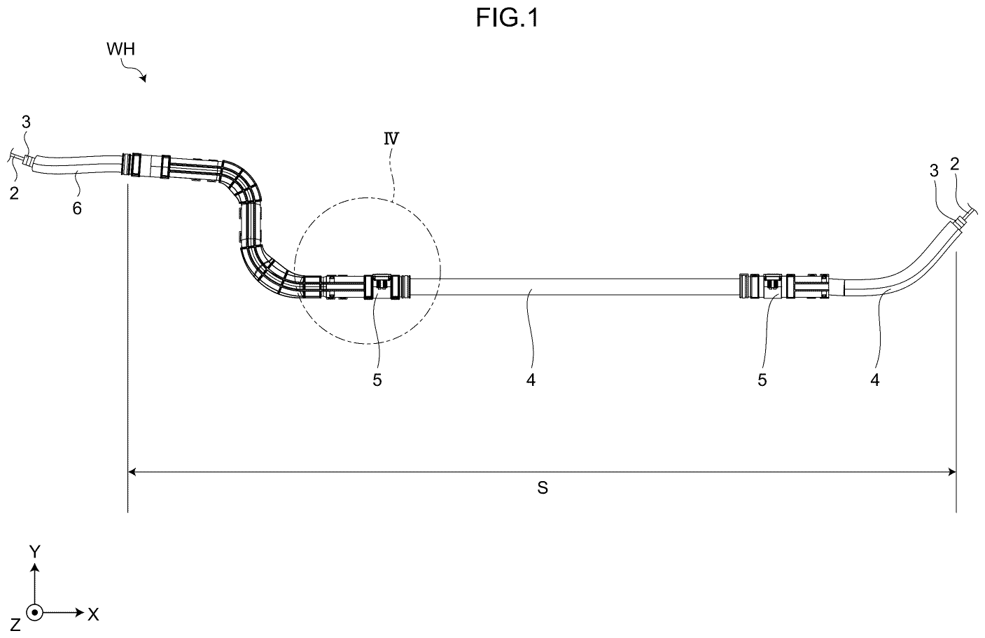

As illustrated in FIG. 1, a wire harness WH according to the present embodiment performs electrical connection by a wiring member 2, and is used by being routed in a vehicle, for example. The wire harness WH includes the wiring member 2, a corrugated tube 3, a hard tube 4, and a protector 5. The wiring member 2 is an electric wire having a linear conductive member, and for example, a covered electric wire in which a conductive member is covered with an insulating coating is used. The wiring member 2 may be a wire bundle obtained by bundling a plurality of wires, or may be a wire bundle around which a tape or the like is wound.

The corrugated tube 3 is a bellows-shaped tube body, and is flexible and can be installed in a curved manner. The corrugated tube 3 externally covers the wiring member 2. The corrugated tube 3 is a slitless tube body, and has no slit formed along the extending direction. Therefore, the corrugated tube 3 can enhance the water stop function or the waterproof function, and can appropriately protect the wiring member 2 inserted into the corrugated tube 3 from water or the like. In a three-dimensional shape restriction section S, the corrugated tube 3 covers the outer periphery of the wiring member 2. The three-dimensional shape restriction section S is a section in which the routing path of the wire harness WH is set as a three-dimensional path. That is, in the three-dimensional shape restriction section S, the wire harness WH is routed while being restricted or held along the set three-dimensional routing path.

The hard tube 4 is a tube body that externally covers the corrugated tube 3. The hard tube 4 is a tube body formed of a material harder or higher in strength than the corrugated tube 3, and is provided to cover the outer periphery of the corrugated tube 3. The hard tube 4 is made of resin, and is lighter than a metal tube body. As the hard tube 4, a resin material can be selected according to a function requirement. For example, when heat resistance is required as the hard tube 4, one formed of a PA material (polyamide resin material) is used. In addition, when calcium chloride resistance is required as the hard tube 4, one formed of a PP material (polypropylene resin material) is used. The hard tube 4 is, for example, a tube body extending linearly in the extending direction X, is disposed in a routing path of a linear region of the wiring member 2, and linearly holds the wiring member 2.

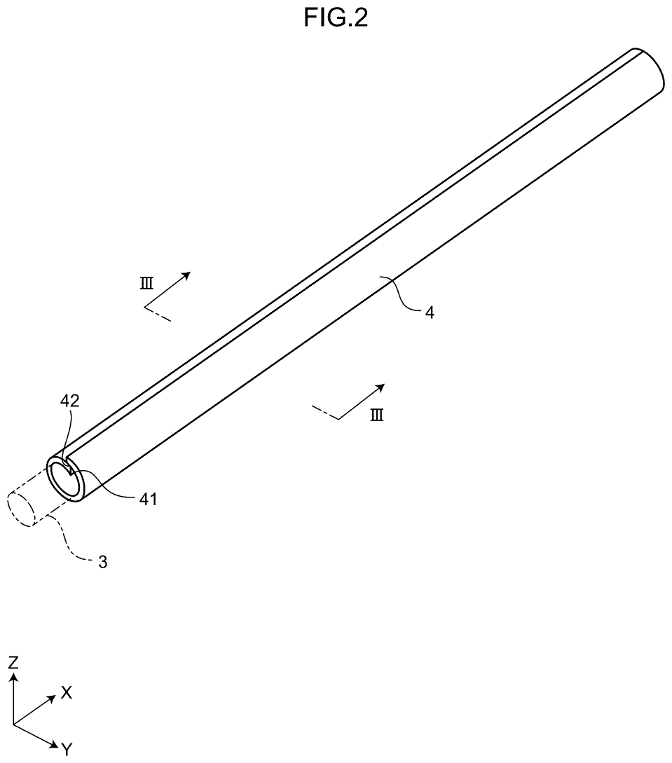

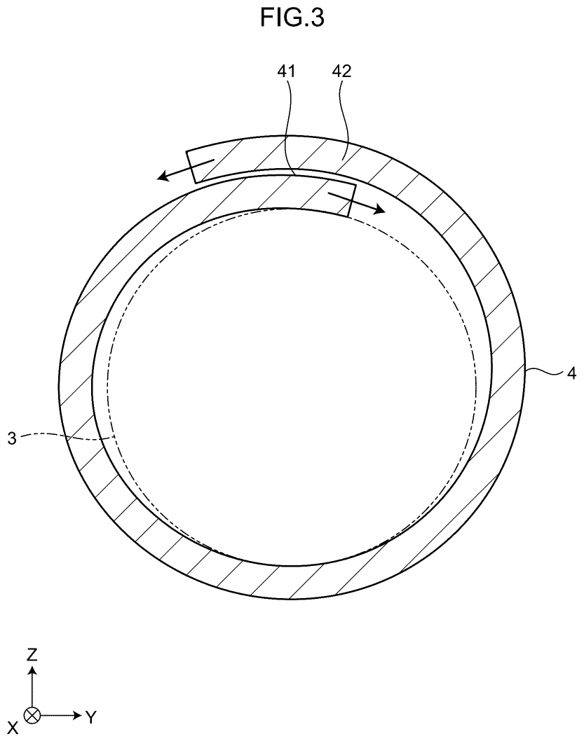

As illustrated in FIGS. 2 and 3, the hard tube 4 forms the cut portion 41 over the entire length along the extending direction X. The cut portion 41 is a slit obtained by cutting out the cylindrical hard tube 4 along the longitudinal direction. By forming the cut portion 41, the hard tube 4 can be easily attached to the wiring member 2 and the corrugated tube 3 in a later process. For example, the hard tube 4 can be conveyed separately from the wiring member 2, the corrugated tube 3, and the like to the wiring location of the wire harness WH, and can be attached to the corrugated tube 3 at the wiring location. Therefore, the wire harness WH can be conveyed as a plurality of packaged objects, the packaged object can be reduced in size, and the conveyance efficiency can be enhanced. In addition, the hard tube 4 can be formed by extrusion molding by being configured separately from the protector 5. Therefore, a mold for molding the hard tube 4 can be downsized, and the hard tube 4 can be manufactured at low cost.

The hard tube 4 has a winding portion 42. The winding portion 42 is a part in which the end portion in the peripheral direction of the hard tube 4 in which the cut portion 41 is formed is wound and overlaps in an inner and outer double layer. Since the hard tube 4 has the winding portion 42, the inside of the hard tube 4 is not exposed to the outside even when the cut portion 41 is formed. Therefore, the hard tube 4 can suppress the corrugated tube 3 from slipping out of the hard tube 4 through the cut portion 41.

In addition, the hard tube 4 can suppress relative movement of the corrugated tube 3 inside by forming the winding portion 42. For example, by setting the inner diameter of the hard tube 4 to be equal to or smaller than the outer diameter of the corrugated tube 3, the inner peripheral surface of the hard tube 4 can be brought into contact with the outer peripheral surface of the corrugated tube 3, and the outer peripheral surface of the corrugated tube 3 can be tightened with the inner peripheral surface. Therefore, the wire harness WH can suppress generation of vibration or abnormal noise due to repeated contact between the hard tube 4 and the corrugated tube 3.

As illustrated in FIG. 1, the protector 5 is a resin-made cylindrical body having a cylindrical shape and externally covering the corrugated tube 3, and is disposed at an end portion of the hard tube 4 and coupled to the hard tube 4. The protector 5 is made of a hard resin or a resin having higher strength than the corrugated tube 3. The protector 5 has a function of covering the outer periphery of the corrugated tube 3 to protect the corrugated tube 3, and a function of restricting the movement of the hard tube 4 in the extending direction X. In addition, the protector 5 has a function of restricting and holding the wire harness WH along a predetermined path.

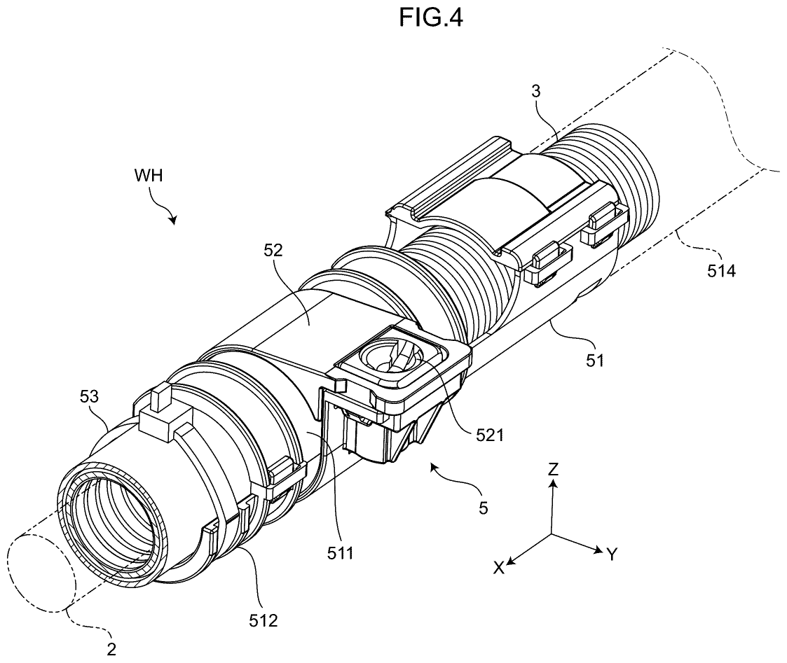

As illustrated in FIG. 4, the protector 5 includes a main body portion 51. The main body portion 51 has a cylindrical shape, is provided at the end portion of the hard tube 4, and is disposed to cover the end portion of the hard tube 4 and the corrugated tube 3. For example, the main body portion 51 has a coupling portion 512 having a semicircular arc cross section at an end portion in the extending direction X. The coupling portion 512 is disposed at a position covering the hard tube 4 and is provided to cover a part of the outer periphery of the hard tube 4. A binding band 53 is attached to the coupling portion 512 along the peripheral direction. The binding band 53 is attached to wind and tighten the coupling portion 512 and the outer periphery of the hard tube 4. The protector 5 and the hard tube 4 are coupled by the binding band 53.

The protector 5 includes an attachment portion 511. The attachment portion 511 is a part to which a fixing member 52 is attached, is formed in a cylindrical shape, and is provided adjacent to the coupling portion 512, for example. The fixing member 52 is a component that fixes the wire harness WH to the vehicle that is the object to be fixed. The fixing member 52 has a cylindrical shape and is attached to the outer periphery of the attachment portion 511. The fixing member 52 has an insertion portion 521 through which a stud bolt or the like provided in the vehicle is inserted. The insertion portion 521 is an insertion hole formed along a direction intersecting the extending direction X. In the protector 5, the cylindrical part such as the attachment portion 511 is configured by pivotally attaching two members having an arc-shaped cross section to be rotatable about the axis in the extending direction X. That is, the protector 5 can be easily attached to the outer periphery of the corrugated tube 3 by opening one of the members having an arc-shaped cross section. The arc shape here includes a substantially arc shape. The two members having an arc-shaped cross section of the cylindrical part of the protector 5 are locked by the lock mechanism not to be opened in the closed state.

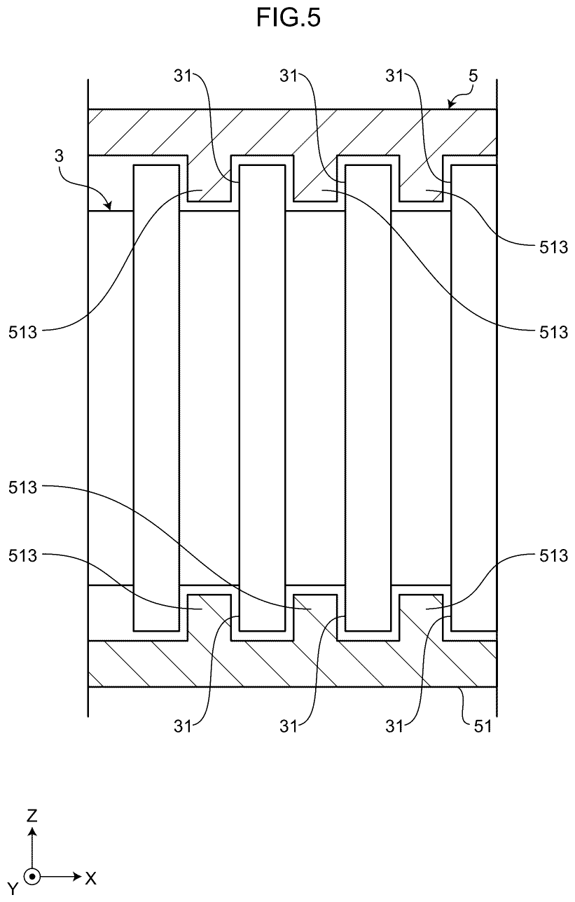

As illustrated in FIG. 5, the protector 5 includes a locking portion 513. The locking portion 513 is a part that protrudes from the inner peripheral surface of the protector 5 and locks the corrugated tube 3. The locking portion 513 is formed in a part of the protector 5 covering the outer periphery of the corrugated tube 3. For example, the locking portion 513 is formed in a part of the protector 5 that is configured by pivotally attaching two members each having an arc-shaped cross section to be rotatable about the axis in the extending direction X. The locking portion 513 is formed in a size that can be inserted into a recess portion 31 of the bellows portion of the corrugated tube 3. For example, a plurality of locking portions 513 are formed at the same formation interval as the recess portion 31 along the extending direction X. The locking portion 513 is inserted into the recess portion 31 to suppress the relative movement of the protector 5 with respect to the corrugated tube 3 in the extending direction X. Although the locking portions 513 are formed on both sides of the corrugated tube 3 to sandwich the corrugated tube 3 in FIG. 5, the locking portions 513 may be formed only on one side of the corrugated tube 3.

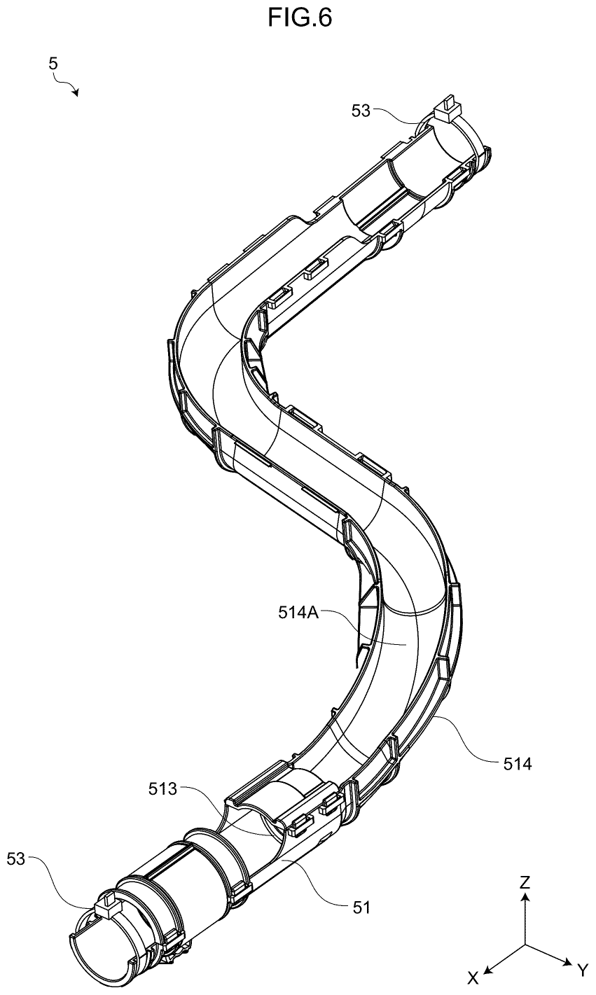

As illustrated in FIG. 6, the protector 5 includes a holding portion 514. The holding portion 514 is a part joined to the main body portion 51 and extending in the extending direction X. The holding portion 514 is formed along a path including a curved part of the routing path of the wiring member 2, and holds the wiring member 2 and the corrugated tube 3 to restrict the path. That is, since the protector 5 includes the holding portion 514, it is possible to restrict the path of the section including the curved part of the wire harness WH. The holding portion 514 is formed in an arc shape in cross section and has an opening portion 514A. The holding portion 514 can be assembled to cover the outer periphery of the corrugated tube 3 through the opening portion 514A, and can be assembled in a later process. Further, by winding and providing the binding band 53 around the end portion of the holding portion 514, the protector 5 can be coupled to the hard tube 4. Note that the protector 5 can also be used as a member that connects the two hard tubes 4 without providing the holding portion 514.

Next, a method of using the wire harness WH according to the present embodiment will be described.

In FIG. 1, the wire harness WH according to the present embodiment is carried into a factory for assembling a vehicle which is an object to be routed, and is routed on a vehicle body or the like of the vehicle to be used. The wire harness WH can be easily conveyed to the factory. That is, the wire harness WH can be carried into a factory by packaging and conveying the hard tube 4 and the protector that restrict the three-dimensional path shape as separate bodies. Therefore, the entire wire harness WH does not need to be one packaged product, and can be conveyed as a plurality of small packaged products. In this case, the wiring member 2 and the corrugated tube 3 can be folded and packaged small. Therefore, the wire harness WH can be easily conveyed to the factory, and the conveyance efficiency can be enhanced.

The wire harness WH can be easily assembled after being carried into the factory as a later process. That is, the hard tube 4 is formed with the cut portion 41, and can be easily attached to the outer periphery of the corrugated tube 3 through which the wiring member 2 is inserted. The protector 5 can also be easily attached to the outer periphery of the corrugated tube 3 by opening one of the members having an arc-shaped cross section of the cylindrical part.

Then, in the assembly of the wire harness WH, the hard tube 4 is disposed at a position where the hard tube 4 is linearly routed, and the protector 5 is disposed at an end portion of the hard tube 4. At this time, as illustrated in FIG. 5, since the locking portion 513 is formed, the movement of the protector 5 in the extending direction X from a preset arrangement position is suppressed. In addition, the protector 5 and the hard tube 4 are coupled by the binding band 53. Therefore, the hard tube 4 is suppressed from moving relative to the corrugated tube 3 in the extending direction X via the protector 5.

In the wire harness WH, the hard tube 4 and the protector 5 are attached to the outer periphery of the corrugated tube 3 through which the wiring member 2 is inserted, and accordingly, the routing path is restricted and held in the three-dimensional shape restriction section S set in advance. Since the hard tube 4 and the protector 5 are formed of resin, the wire harness WH can be reduced in weight and cost compared to a case where a metal tube body is used as an external covering to restrict the routing path.

In the wire harness WH, the hard tube 4 forms the cut portion 41, but the wire harness WH has the winding portion 42 in which the end portion in the peripheral direction of the hard tube 4 forming the cut portion 41 is wound and overlaps in an inner and outer double layer. Therefore, in the wire harness WH, even when the hard tube 4 forms the cut portion 41, the corrugated tube 3 inside is suppressed from being exposed or from being pulled out of the hard tube 4. In the wire harness WH, the inner peripheral surface of the hard tube 4 is brought into contact with the outer peripheral surface of the corrugated tube 3 by the winding portion 42, the outer peripheral surface of the corrugated tube 3 is tightened by the inner peripheral surface, and accordingly, the corrugated tube 3 can be suppressed from moving in the hard tube 4, and the generation of vibration or abnormal noise can be suppressed.

The wire harness WH is fixed to the vehicle body or the like of the vehicle using the fixing member 52. When the fixing step by the fixing member 52 is completed, the wiring work of the wire harness WH is completed.

As described above, the wire harness WH according to the present embodiment includes the resin-made hard tube 4 and the resin-made protector 5, and accordingly, the hard tube 4 and the protector 5 can restrict and hold the three-dimensional routing path. Therefore, the wire harness WH according to the present embodiment can achieve weight reduction compared to the case of using a metal tube body, and can appropriately restrict the path of the wiring member 2.

In addition, in the wire harness WH according to the present embodiment, the protector 5 is provided at the end portion of the hard tube 4 and restricts the movement of the hard tube 4 in the extending direction X, and accordingly, a preset three-dimensional routing path can be appropriately restricted and held.

Further, in the wire harness WH according to the present embodiment, since the protector 5 has the locking portion 513, the protector 5 is suppressed from moving in the extending direction X with respect to the corrugated tube 3, and the hard tube 4 is suppressed from moving in the extending direction X with respect to the corrugated tube 3 via the protector 5. Therefore, the wire harness WH according to the present embodiment can appropriately restrict the three-dimensional routing path set in advance.

Although the wire harness WH according to the present embodiment has been described, the wire harness according to the present invention is not limited to the above-described embodiment, and various modifications can be made within the scope described in the claims. The wire harness WH according to the present embodiment may be configured by appropriately combining the constituent elements of the embodiment and the modifications described above.

For example, although the case where the wire harness WH according to the above-described embodiment is mounted on the vehicle has been described, the wire harness WH may be used without being mounted on the vehicle.

According to the wire harness of the present embodiment, it is possible to appropriately restrict the path of the wiring member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a wiring member;
a bellows-shaped corrugated tube that has a cylindrical shape and externally covers the wiring member;
a resin-made hard tube that has a cylindrical shape, externally covers the corrugated tube, and forms a cut portion over an entire length along an extending direction; and
a resin-made protector that has a cylindrical part, externally covers the corrugated tube, is disposed at an end portion of the hard tube, and is coupled to the hard tube.

2. The wire harness according to claim 1, wherein
the hard tube is provided in a linear region in which the wiring member is linearly routed, and
the protector restricts movement of the hard tube in the extending direction at the end portion of the hard tube.

3. The wire harness according to claim 2, wherein
the protector includes a locking portion that protrudes from an inner peripheral surface and is fitted into a recess portion of a bellows portion of the corrugated tube.
